(19) United States
(12) Patent Application Publication
(10) Pub. No.: US 2012/0135306 A1
(43) Pub. Date: May 31, 2012

(54) NEGATIVE ELECTRODE FOR NON-AQUEOUS ELECTROLYTE SECONDARY BATTERY, METHOD FOR PRODUCING THE SAME, AND NON-AQUEOUS ELECTROLYTE SECONDARY BATTERY

(76) Inventor: Hiroshi Temmyo, Osaka (JP)

(21) Appl. No.: 13/388,642

(22) PCT Filed: Mar. 24, 2011
(86) PCT No.: PCT/JP2011/001741

§ 371 Date: Feb. 2, 2012

(30) Foreign Application Priority Data
Mar. 29, 2010 (JP) 2010 074737

(51) Int. Cl. H01M 4/131; B05D 3/12; H01M 4/74; H01M 4/04

(52) U.S. Cl. 429/211; 427/122

(57) ABSTRACT

A negative electrode for a non-aqueous electrolyte secondary battery of the invention includes: a sheet-like current collector with a plurality of through-holes; a carbon layer formed on a surface of and in the through holes of the current collector; and a mixture layer formed on a surface of the carbon layer. The mixture layer includes an active material and a conductive agent, and the active material includes a lithium-titanium containing composite oxide with a spinel crystal structure. The current collector has a void ratio of 20 to 60%. The carbon layer has an average density of 0.05 to 0.4 g/cm³. The use of this negative electrode can provide a non-aqueous electrolyte secondary battery with good rate characteristics and cycle characteristics.

### TECHNICAL FIELD

This invention relates to a non-aqueous electrolyte secondary battery, and particularly to an improvement in the negative electrode used therefor.

### BACKGROUND ART

Non-aqueous electrolyte secondary batteries with high electromotive force and energy density have been widely used as the power source for portable electronic appliances. Non-aqueous electrolyte secondary batteries are also used as the batteries for automobiles, and attempts have been made to improve their performance such as output characteristics so that they are suited for automotive applications.

The electrodes of non-aqueous electrolyte secondary batteries usually include a metal current collector and a mixture layer that is formed on a surface of the current collector and contains an active material.

To heighten the current-collection efficiency of the electrodes and improve their ability to retain mixture layers, attempts have been made to use, as the current collector, a porous substrate (PTLs 1 and 2) or a metal foil with a plurality of through-holes (PTLs 3 and 4).

### CITATION LIST

### Patent Literature

[PTL 1] Japanese Laid-Open Patent Publication No. Hei 9-45334
[PTL 2] Japanese Laid-Open Patent Publication No. 2008-41971
[PTL 3] Japanese Laid-Open Patent Publication No. Hei 11-67218
[PTL 4] Japanese Laid-Open Patent Publication No. 2008-59765

### SUMMARY OF INVENTION

### Technical Problem

However, according to the methods of PTLs 1 to 4, when the charge/discharge is repeated, the active material of the mixture layer filled into the pores/holes of the current collector expands and contracts, which may result in the deformation and breakage of the current collector and the separation of the mixture layer. If the mixture layer separates, the resistance of the electrode increases, so that the charge/discharge cycle characteristics deteriorate.

One solution to this problem is to use, as an active material, a lithium-titanium containing composite oxide with a spinel crystal structure which hardly expands or contracts during charge/discharge.

However, titanium-based active materials have poor heat conductivity and tend to cause unevenness of heat inside batteries during charge/discharge cycles. Thus, they cannot improve charge/discharge cycle characteristics sufficiently.

It is therefore an object of the invention to provide a non-aqueous electrolyte secondary battery with good charge/discharge cycle characteristics.

### Solution to Problem

One aspect of the invention relates to a non-aqueous electrolyte secondary battery, including: a sheet-like current collector with a plurality of through-holes; a carbon layer formed on a surface of and in the through holes of the current collector; and a mixture layer formed on a surface of the carbon layer. The mixture layer includes an active material and a conductive agent, and the active material includes a lithium-titanium containing composite oxide with a spinel crystal structure. The current collector has a void ratio of 20 to 60%, and the carbon layer has an average density of 0.05 to 0.4 g/cm³.

Another aspect of the invention relates to a non-aqueous electrolyte secondary battery including a positive electrode, the above-mentioned negative electrode, a separator disposed between the positive electrode and the negative electrode, and a non-aqueous electrolyte.

Still another aspect of the invention relates to a method for producing a negative electrode for a non-aqueous electrolyte secondary battery. This method includes the steps of: (a) applying a first paste including a carbon material onto a surface of a sheet-like current collector having a plurality of through-holes and a void ratio of 20 to 60% and drying it to form a carbon layer on a surface of and in the through-holes of the current collector; (b) applying a second paste including a lithium-titanium containing composite oxide with a spinel crystal structure as an active material and a conductive agent onto a surface of the carbon layer and drying it to form a mixture layer, thereby producing a negative electrode precursor; and (c) compressing the negative electrode precursor such that the carbon layer has an average density of 0.05 to 0.4 g/cm³, to produce a negative electrode.

### Advantageous Effects of Invention

The invention can improve the charge/discharge cycle characteristics of the non-aqueous electrolyte secondary battery.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 is a schematic longitudinal sectional view of an example of a negative electrode for a non-aqueous electrolyte secondary battery according to the invention; and

FIG. 2 is a partially sectional front view of a cylindrical non-aqueous electrolyte secondary battery produced in an Example of the invention.

### DESCRIPTION OF EMBODIMENTS

The negative electrode for a non-aqueous electrolyte secondary battery according to the invention has the following features i) to iv):

i) The negative electrode includes a sheet-like current collector with a plurality of through-holes; a carbon layer formed on a surface of and in the through holes of the current collector; and a mixture layer formed on a surface of the carbon layer.

ii) The mixture layer includes a lithium-titanium containing composite oxide with a spinel crystal structure (hereinafter a “titanium-based active material”) as an active material and a conductive agent.

iii) The current collector has a void ratio of 20 to 60%.

iv) The carbon layer has an average density of 0.05 to 0.4 g/cm³.

In i) above, the carbon layer formed on a surface of the current collector refers to a carbon layer covering a main surface of the current collector. In i) above, the carbon layer formed in the through-holes refers to parts of the carbon layer covering the main surface of the current collector which are embedded in the through-holes. These embedded parts occupy parts of the spaces in the through-holes.

The invention uses a titanium-based active material which hardly expands or contracts during charge/discharge as the negative electrode active material. This can suppress fall-off of the active material from the current collector during charge/discharge and a decrease in electronic conductivity between the active material particles due to poor contact between the active material particles. However, the titanium-based active material has poor heat conductivity, thus posing a problem in that it tends to cause unevenness of heat inside the battery during charge/discharge cycles.

An effective method for preventing such unevenness of heat may be to provide a current collector with a plurality of through-holes in the thickness direction and allow the through-holes to retain an electrolyte to improve the heat conductivity of the current collector in the thickness direction. However, according to a conventional method for producing an electrode, a mixture paste containing an active material is directly applied onto a surface of a current collector with a plurality of through-holes and is dried to form a mixture layer. In such a conventional electrode production method, it is difficult to allow the through-holes to retain an electrolyte since the active material is embedded into the through-holes of the current collector.

According to the invention, in order to prevent the mixture from being embedded into the through-holes of the current collector, the surface of a current collector is coated with a carbon layer, and a mixture layer is disposed on the carbon layer. Further, the density of the regions of the carbon layer comprising the parts formed in the through-holes and the parts extending therefrom in the thickness direction of the current collector is made low. This makes it possible to provide sufficient spaces inside the negative electrode for retaining a non-aqueous electrolyte which has a high heat capacity and allows heat to easily diffuse therethrough, thereby improving the heat conductivity of the current collector in the thickness direction. It is therefore possible to suppress unevenness of heat in the battery upon repeated charge/discharge caused by the use of the titanium-based active material, and improve the charge/discharge cycle characteristics.

The carbon layer has the function of increasing the electronic conductivity between the current collector and the mixture layer and the function of improving electrolyte retention. Since the carbon layer has low density regions, the average density of the whole carbon layer is 0.05 to 0.4 g/cm³, which is lower than the density (approximately 0.5 g/cm³) without any through-holes. When the average density of the carbon layer is in the above range, an electrode with good electronic conductivity and electrolyte retention can be obtained.

Further, by setting the void ratio of the current collector to 20 to 60%, the current collector has sufficient strength, and at the same time, a sufficient amount of electrolyte is retained in the electrolyte retention sites of the current collector, thereby permitting smooth movement of lithium ions into the interior of the negative electrode. As a result, the rate characteristics of the non-aqueous electrolyte secondary battery improve. As used herein, the void ratio refers to the ratio of the total volume of the through-holes to the total volume of the current collector and the through-holes.

Due to the satisfaction of the above conditions i) to iv), it is possible to provide a non-aqueous electrolyte secondary battery with good charge/discharge cycle characteristics and rate characteristics.

The through-holes of the current collector are holes provided for retaining the electrolyte. They are holes penetrating through at least the thickness of the current collector, i.e., holes penetrating through the sheet-like current collector from one surface thereof to the other surface. The through-holes are, for example, substantially circular, oval, or substantially polygonal such as substantially quadrangular in a cross-section perpendicular to the thickness direction of the current collector.

In order to achieve a good balance between the strength of the current collector and its heat conductivity in the thickness direction, the average diameter (when being not substantially circular, the average largest size) of the through-holes is preferably 100 to 700 μm, more preferably 200 to 600 μm, and even more preferably 250 to 500 μm.

The current collector is formed of, for example, perforated metal sheet, expanded metal, or a mesh-like metal plate. The mixture layer and the carbon layer can be formed on one or both surfaces of the current collector.

In terms of the output characteristics and capacity of the battery, the content of the active material in the mixture layer is preferably 1.5 to 2.3 g per 1 cm³ of the mixture layer. By setting the content of the active material in the mixture layer to 1.5 g or more per 1 cm³ of the mixture layer, the mixture layer can contain a sufficient amount of active material, thereby providing a sufficient negative electrode capacity. By setting the content of the active material in the mixture layer to 2.3 g or less per 1 cm³ of the mixture layer, the mixture layer can retain a sufficient amount of electrolyte, thereby providing good charge/discharge cycle characteristics.

The invention relates to a non-aqueous electrolyte secondary battery including a positive electrode, the above-described negative electrode, a separator disposed between the positive electrode and the negative electrode, and a non-aqueous electrolyte.

In the battery, 30 to 90% by volume of the spaces inside the through-holes (the voids of the current collector) are preferably filled with the non-aqueous electrolyte. That is, 10 to 70% by volume of the spaces inside the through-holes are preferably occupied by a carbon material and a binder. If at least 30% by volume of the spaces inside the through-holes are filled with the non-aqueous electrolyte, the charge/discharge cycle characteristics improve.

The ratio P (% by volume) of the non-aqueous electrolyte inside the through-holes can be determined, for example, by the following method. A cross-section of the negative electrode in the thickness direction is observed with a scanning electron microscope (SEM). Using an image processing of the SEM, the ratio of the volume Rᵥ of the spaces inside the through-holes in which the electrolyte is retained to the volume Qᵥ of the through-holes, i.e., the ratio Rᵥ/Qᵥ, is determined. The value P is given as Rᵥ/Qᵥ×100.

The volume Rᵥ of the spaces inside the through-holes in which the electrolyte is retained can be determined by, for example, binarizing the SEM image so that the spaces inside the through-holes can be clearly identified. The magnification of the image (projected image) is, for example, 200 to 1000. The area of the image (projected image) is, for example, 50 to 100 μm×50 to 100 μm. The number of pixels dividing the image (projected image) is, for example, 480 to 1024×480 to 1024. Each pixel is binarized. This process is applied to a cross-section of one through-hole in the thickness direction of the negative electrode.

The positive electrode has a current collector and a mixture layer formed on a surface of the current collector. The mixture layer of the positive electrode includes, for example, an active material, a conductive agent, and a binder. The positive electrode can be produced, for example, by the following method. A mixture of the active material, the conductive agent, and the binder is mixed with a dispersion medium to form a paste. This paste is applied onto a surface of the current collector to form a coating. The coating is dried to form a mixture layer, which is then compressed. The mixture layer of the positive electrode can be formed on one or both surfaces of the current collector of the positive electrode.

The active material of the positive electrode can be a lithium-containing composite oxide capable of reversibly absorbing and desorbing lithium. Representative examples of lithium-containing composite oxides include LiCoO₂, LiNiO₂, LiMn₂O₄, LiMnO₂, LiNi_{1-y}CO_{y}O₂ where 0<y<1, and LiNi_{1-y-z}CO_{y}Mn_{z}O₂ where 0<y+z<1.

The binder for the positive electrode can be, for example, a fluorocarbon resin such as polytetrafluoroethylene (PTFE) or polyvinylidene fluoride (PVDF). The conductive agent for the positive electrode can be the same material as that used as the conductive agent for the negative electrode.

The current collector for the positive electrode can be, for example, a metal foil such as aluminum foil or aluminum alloy foil. The thickness of the current collector for the positive electrode is, for example, 10 to 30 μm.

The separator can be an insulating microporous thin film having large ion permeability and a predetermined mechanical strength. Specifically, a sheet or non-woven fabric comprising one or more olefin polymers such as polypropylene and polyethylene or comprising glass fibers is used.

The desirable pore size of the separator is such that the active material, binder, conductive agent, etc. having fallen off the electrode sheet do not pass through, and is, for example, 0.1 to 1 μm. The preferable thickness of the separator is usually 10 to 100 μm. Also, while the porosity is determined according to the electron or ion permeability, the material, and the thickness, the desirable porosity is usually 30 to 80%.

The non-aqueous electrolyte is composed of a non-aqueous solvent and a lithium salt dissolved in the solvent.

Examples of usable non-aqueous solvents include cyclic carbonates, cyclic carboxylic acid esters, non-cyclic carbonates, and aliphatic carboxylic acid esters. Preferable non-aqueous solvents are solvent mixtures of one or more cyclic carbonates and one or more non-cyclic carbonates and solvent mixtures of one or more cyclic carboxylic acid esters and one or more cyclic carbonates.

Specific examples of non-aqueous solvents include cyclic carbonates such as ethylene carbonate (EC), propylene carbonate (PC), butylene carbonate (BC), and vinylene carbonate (VC), non-cyclic carbonates such as dimethyl carbonate (DMC), diethyl carbonate (DEC), ethyl methyl carbonate (EMC), and dipropyl carbonate (DPC), aliphatic carboxylic acid esters such as methyl formate (MF), methyl acetate (MA), methyl propionate (MP), and ethyl propionate (MA), and cyclic carboxylic acid esters such as γ-butyrolactone (GBL).

Preferable cyclic carbonates are EC, PC, and VC. A preferable cyclic carboxylic acid ester is GBL. Preferable non-cyclic carbonates are DMC, DEC, and EMC. It is also preferable to contain an aliphatic carboxylic acid ester, if necessary.

Examples of lithium salts include LiClO₄, LiBF₄, LiPF₆, LiAlCl₄, LiSbF₆, LiSCN, LiCF₃SO₃, LiCF₃CO₂, Li(CF₃SO₂)₂, LiAsF₆, LiN(CF₃SO₂)₂, chloroborane lithium such as LiB₁₀Cl₁₀, lithium lower aliphatic carboxylates, lithium tetraphenylborate, and imides such as LiN(CF₃SO₂) (C₂F₅SO₂), LiN(CF₂SO₂)₂, LiN(C₂F₅SO₂)₂, and LiN(cF₃SO₂)(C₄F₉SO₂). Among them, LiPF₆ is preferable.

While the concentration of the lithium salt in the non-aqueous electrolyte is not particularly limited, it is preferably 0.2 to 2 mol/L, and more preferably 0.5 to 1.5 mol/L.

The battery may be of any shape such as a coin, button, sheet, cylindrical, flat, or prismatic shape.

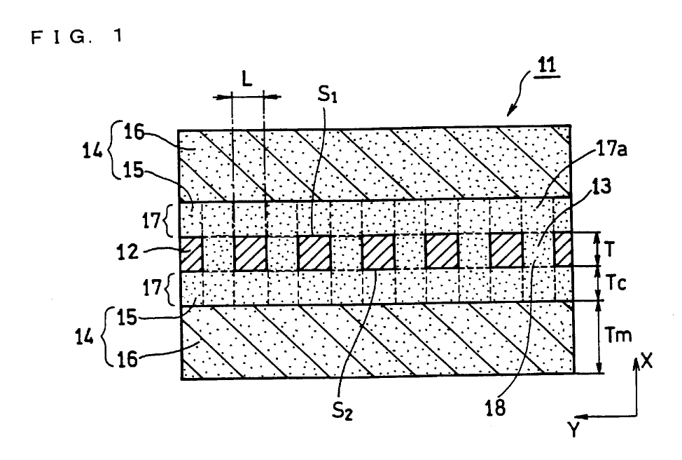

With reference to FIG. 1, one embodiment of the negative electrode of the invention is hereinafter described, but the invention is not to be construed as being limited thereto. FIG. 1 is a schematic representation and different from actual dimensions.

As illustrated in FIG. 1, a negative electrode 11 has a sheet-like current collector 12 and a composite layer 14 formed on each face of the current collector 12. The composite layer 14 is composed of a carbon layer 15 including a carbon material and a mixture layer 16 including an active material. The current collector 12 comprises a perforated metal sheet with a plurality of through-holes 13. The mixture layer 16 is formed over the current collector 12, with the carbon layer 15 interposed therebetween.

The carbon layer 15 comprises: surface-covering parts 17 which cover one surface S₁ and the other surface S₂ of the current collector 12; and hole-filling parts 18 which are filled into the holes 13. In the regions (hereinafter “less-dense regions”) comprising the hole-filling parts 18 and extended parts 17a which extend from the hole-filling parts 18 in the thickness direction of the current collector 12, a carbon material is loosely filled to make the density low. As a result, spaces for retaining the electrolyte are formed in the less-dense regions. The density of the carbon layer is low mainly inside the hole-filling parts 18. That is, most of the spaces are formed inside the through-holes 13. Inside the through-holes 13, a large number of small spaces may be formed, or large spaces may be formed in some areas.

The carbon material loosely filled in the less-dense regions can be confirmed, for example, by observing a cross-section of the negative electrode with a scanning electron microscope (SEM) or the like.

By setting the average density of the carbon layer 15 to 0.05 to 0.4 g/cm³, the rate characteristics and charge/discharge cycle characteristics improve. To obtain good rate characteristics and charge/discharge cycle characteristics, the average density of the carbon layer 15 is preferably 0.05 to 0.3 g/cm³. To obtain particularly good charge/discharge cycle characteristics, the average density of the carbon layer 15 is preferably 0.1 to 0.3 g/cm³.

To suppress the active material from being embedded into the through-holes, the lower limit of average density of the carbon layer is 0.05 g/cm³, preferably 0.1 g/cm³, and more preferably 0.15 g/cm³. In terms of the electrolyte retention of the negative electrode, the upper limit of average density of the carbon layer is 0.4 g/cm³, preferably 0.3 g/cm³, and more preferably 0.25 g/cm³. The range of average density of the carbon layer may be any combination of such an upper limit and a lower limit as mentioned above.

The average density of the carbon layer 15 can be determined by the following formula:

average density of carbon layer 15=(amount of carbon material filled)/(volume of surface-covering parts 17+total volume of through-holes 13)

The volume of the surface-covering parts 17 can be obtained by multiplying the area of the surface-covering parts 17 facing the current collector (including the through-holes 13) and the thickness of the surface-covering parts 17 together.

In terms of rate characteristics and charge/discharge cycle characteristics, the weight of the carbon material contained per 1 cm³ of the through-holes is preferably 0.05 to 0.35 g, and more preferably 0.05 to 0.15 g.

The through-holes 13 extend from one surface S₁ to the other surface S₂ in the thickness direction X of the current collector 12. The through-holes 13 are substantially circular in a cross-section along the plane direction Y of the current collector 12.

To achieve a good balance between the strength of the current collector and the heat conductivity in the thickness direction, the average diameter of the through-holes 13 is preferably 100 to 700 μm, more preferably 200 to 600 μm, and even more preferably 250 to 500 μm.

In terms of the strength of the current collector, the upper limit of average diameter of the through-holes 13 is preferably 700 μm, more preferably 600 μm, and even more preferably 500 μm. In terms of the heat conductivity of the current collector in the thickness direction and charge/discharge cycle characteristics, the lower limit of average diameter of the through-holes 13 is preferably 100 μm, more preferably 200 μm, and even more preferably 250 μm. The range of average value of the through-holes may be any combination of such an upper limit and a lower limit as mentioned above.

The interval L between the through-holes 13 in FIG. 1 is preferably 100 to 1000 μm. By setting the interval L between the through-holes 13 to 100 μm or more, the surface of the current collector 12 can be stably covered with the carbon layer. By setting the interval L between the through-holes 13 to 1000 μm or less, sufficient heat conductivity of the current collector in the thickness direction can be obtained. In terms of evenness of the negative electrode reaction, it is preferable that the through-holes 13 of a uniform size be provided at a uniform interval.

The void ratio of the current collector 12 is 20 to 60%. As used herein, the void ratio refers to the ratio of the total volume of the through-holes 13 to the total volume of the current collector 12 and the through-holes 13.

By setting the void ratio of the current collector to 20% or more, the current collector can retain a sufficient amount of electrolyte, thereby improving the rate characteristics. Also, the heat conductivity of the current collector in the thickness direction is sufficiently improved. By setting the void ratio of the current collector to 60% or less, the current collector has sufficient strength, and the carbon material is prevented from being excessively filled into the through-holes. The void ratio of the current collector 12 is preferably 30 to 50%, and more preferably 35 to 45%.

In terms of the electrolyte retention of the current collector, the lower limit of void ratio of the current collector is 20%, preferably 30%, and more preferably 35%. To provide the current collector with sufficient strength and suppress the carbon material from being excessively filled into the through-holes, the upper limit of void ratio of the current collector is 60%, preferably 50%, and more preferably 45%. The range of void ratio of the current collector may be any combination of such an upper limit and a lower limit as mentioned above.

The void ratio of the current collector can be adjusted by changing the size of the through-holes, the interval L, etc. The void ratio of the current collector can be calculated from the average diameter of the through-holes and the thickness of the current collector.

The thickness T of the current collector 12 is preferably 5 to 40 μm, and more preferably 5 to 25 μm. By setting the thickness T of the current collector 12 to 5 μm or more, the current collector can retain a sufficient amount of electrolyte, thereby significantly improving the charge/discharge cycle characteristics. By setting the thickness T of the current collector 12 to 40 μm or less, the thickness of the negative electrode can be made sufficiently small, thereby providing a high energy density battery.

In terms of the strength of the current collector, the electrolyte retention thereof, and the heat conductivity thereof in the thickness direction, the ratio of the average diameter R of the through-holes 13 to the thickness T of the current collector 12, i.e., the ratio R/T, is preferably from 2.5 to 60, and more preferably from 15 to 50.

The material of the current collector 12 is preferably aluminum or an aluminum alloy. In terms of electrolyte resistance and strength, the aluminum alloy preferably includes aluminum and at least one selected from the group consisting of copper, manganese, silicon, magnesium, zinc, and nickel. The content of the element(s) other than aluminum in the aluminum alloy is preferably 0.05 to 0.3% by weight.

The carbon layer 15 includes a carbon material and a first binder.

Examples of the carbon material include carbon blacks such as acetylene black, ketjen black, channel black, furnace black, lamp black, and thermal black, carbon fibers, and graphite. Among them, the carbon material is preferably acetylene black.

The carbon material may be in the form of particles or fibers. The carbon material in the form of particles preferably has a volume basis mean particle size (D50) of 10 to 50 nm. The carbon material in the form of fibers preferably has an average fiber length of 0.1 to 20 μm and an average fiber diameter of 5 to 150 nm.

Examples of the first binder include styrene butadiene rubber (SBR), polyethylene (PE), polypropylene (PP), and fluorocarbon resins. Examples of fluorocarbon resins include polytetrafluoroethylene (PTFE), polyvinylidene fluoride (PVDF), tetrafluoroethylene-hexafluoropropylene copolymers (FEP), tetrafluoroethylene-perfluoroalkylvinylether copolymers (PFA), vinylidene fluoride-hexafluoropropylene copolymers, vinylidene fluoride-chlorotrifluoroethylene copolymers, ethylene-tetrafluoroethylene copolymers (ETFE resins), polychlorotrifluoroethylene (PCTFE), vinylidene fluoride-pentafluoropropylene copolymers, propylene-tetrafluoroethylene copolymers, ethylene-chlorotrifluoroethylene copolymers (ECTFE), vinylidene fluoride-hexafluoropropylene-tetrafluoroethylene copolymers, and vinylidene fluoride-perfluoromethylvinylether-tetrafluoroethylene copolymers. In terms of the strength of the carbon layer, PTFE and PVDF are particularly preferable.

The content of the first binder in the carbon layer 15 is preferably 150 to 300 parts by weight per 100 parts by weight of the carbon material, more preferably 175 to 275 parts by weight per 100 parts by weight of the carbon material, and even more preferably 200 to 250 parts by weight per 100 parts by weight of the carbon material.

By setting the content of the first binder in the carbon layer 15 to 150 parts by weight or more per 100 parts by weight of the carbon material, the adhesion between the carbon material and the adhesion between the carbon layer and the current collector become sufficient. By setting the content of the first binder in the carbon layer 15 to 300 parts by weight or less per 100 parts by weight of the carbon material, the carbon layer can contain a sufficient amount of carbon material, thereby providing sufficient electronic conductivity between the mixture layer and the current collector.

In terms of the adhesion between the carbon material and the adhesion between the carbon layer and the current collector, the lower limit of the content of the first binder in the carbon layer is preferably 150 parts by weight per 100 parts by weight of the carbon material, more preferably 175 parts by weight per 100 parts by weight of the carbon material, and even more preferably 200 parts by weight per 100 parts by weight of the carbon material. In terms of the electronic conductivity of the carbon layer, the upper limit of the content of the first binder in the carbon layer is preferably 300 parts by weight per 100 parts by weight of the carbon material, more preferably 275 parts by weight per 100 parts by weight of the carbon material, and even more preferably 250 parts by weight per 100 parts by weight of the carbon material. The range of the content of the first binder in the carbon layer may be any combination of such an upper limit and a lower limit as mentioned above.

In terms of the electronic conductivity between the current collector and the mixture layer and energy density, the thickness T_{c} of the surface-covering parts 17 of each carbon layer 15 (the thickness per layer) is preferably 5 to 30 μm, and more preferably 5 to 20 μm.

By setting the thickness T_{c} of the surface-covering parts 17 of the carbon layer 15 to 5 μm or more, the carbon layer can sufficiently protect the current collector (through-holes), thereby suppressing the active material from being embedded into the through-holes. By setting the thickness T_{c} of the surface-covering parts 17 of the carbon layer 15 to 30 μm or less, the thickness of the negative electrode can be made sufficiently small, thereby providing a high energy density battery.

The mixture layer 16 contains an active material and a conductive agent, and if necessary, further contains a second binder. As the active material, a titanium-based active material is used. Since the titanium-based active material undergoes almost no volume change due to expansion and contraction upon charge/discharge, a decrease in the adhesion of the mixture layer due to charge/discharge cycles is suppressed.

The titanium-based active material preferably has a structure represented by the general formula Li₄₊ₓTi_{5-y}M_{y}O_{12+z}. Therein, M is at least one selected from the group consisting of Mg, Al, Ca, Ba, Bi, Ga, V, Nb, W, Mo, Ta, Cr, Fe, Ni, Co, and Mn, −1≦x≦1, 0≦y≦1, and −1≦z≦1. It should be noted that x is the value immediately after the synthesis or in the fully discharged state. By replacing part of the Ti with Mg, Al, Ca, Ba, or Ga, the thermal stability improves. Among these, Mg and Al are more preferable. By replacing part of the Ti with Bi, V, Nb, W, Mo, Ta, Cr, Fe, Ni, Co, or Mn, the cycle characteristics improve. Among these, Bi and V are more preferable. Since the volume change due to expansion and contraction upon charge/discharge is particularly small, Li₄Ti₅O₁₂ is particularly preferable as the titanium-based active material. The volume basis mean particle size (D50) of the titanium-based active material is preferably 0.2 to 30 μm.

The conductive agent can be a carbon black used in the carbon layer 15, or can be a graphite such as natural graphite or artificial graphite. Among these, artificial graphite and acetylene black are preferable. The conductive agent is more preferably acetylene black, which is also a carbon black just like the carbon material of the carbon layer.

Also, examples other than carbon materials include metal fibers, fluorinated carbon, metal (e.g., aluminum) powders, conductive whiskers such as zinc oxide and potassium titanate, conductive metal oxides such as titanium oxide, and organic conductive materials such as phenylene derivatives. Among these, nickel powder is particularly preferable.

The content of the conductive agent in the mixture layer 16 is preferably 2 to 15 parts by weight per 100 parts by weight of the active material, and more preferably 3 to 12 parts by weight per 100 parts by weight of the active material. By setting the content of the conductive agent in the mixture layer 16 to 2 parts by weight or more per 100 parts by weight of the active material, the electronic conductivity between the active material particles and the electronic conductivity between the mixture layer and the carbon layer become sufficient. By setting the content of the conductive agent in the mixture layer 16 to 15 parts by weight or less per 100 parts by weight of the active material, the mixture layer can contain a sufficient amount of active material, thereby providing a sufficient negative electrode capacity.

The second binder in the mixture layer 16a can be any material selected from, for example, those listed as the first binders for the carbon layer.

The content of the second binder in the mixture layer 16 is preferably 2 to 6 parts by weight per 100 parts by weight of the active material, and more preferably 3 to 5 per 100 parts by weight of the active material. By setting the content of the second binder in the mixture layer 16 to 2 parts by weight or more per 100 parts by weight of the active material, the adhesion between the active material particles and the adhesion between the mixture layer and the carbon layer become sufficient. By setting the content of the second binder in the mixture layer 16 to 6 parts by weight or less per 100 parts by weight of the active material, the mixture layer can contain a sufficient amount of active material, thereby providing a sufficient negative electrode capacity.

In terms of the supply of the non-aqueous electrolyte into the mixture layer 16 and the amount of active material, the thickness Tₘ of each mixture layer 16 (the thickness per layer) is preferably 20 to 150 μm, and more preferably 20 to 50 μm.

The ratio of the thickness T_{c} of the surface-covering parts 17 of the carbon layer 15 to the thickness Tₘ of the mixture layer 16, i.e., the ratio T_{c}/Tₘ, is preferably from 0.03 to 1.5, and more preferably from 0.1 to 1.5.

In terms of the output characteristics and capacity of the battery, the content of active material in the mixture layer 16 is preferably 1.5 to 2.3 g per 1 cm³ of the mixture layer. By setting the content of active material in the mixture layer 16 to 1.5 g or more per 1 cm³ of the mixture layer, the mixture layer can contain a sufficient amount of active material, thereby providing a sufficient negative electrode capacity. By setting the content of active material in the mixture layer 16 to 2.3 g or less per 1 cm of the mixture layer, the mixture layer can retain a sufficient amount of electrolyte, thereby providing good charge/discharge cycle characteristics.

An example of the method for producing the negative electrode for a non-aqueous electrolyte secondary battery according to the invention is hereinafter described. This method includes the steps of: (a) applying a first paste including a carbon material onto a surface of a sheet-like current collector having a plurality of through-holes and a void ratio of 20 to 60% and drying it to form the carbon layer on a surface of and in the through-holes of the current collector; (b) applying a second paste including a titanium-based active material and a conductive agent on a surface of the carbon layer and drying it to form a mixture layer, thereby producing a negative electrode precursor; and (c) compressing the negative electrode precursor such that the carbon layer has an average density of 0.05 to 0.4 g/cm³, to produce a negative electrode.

### Step (a): Step for Forming Carbon Layer

For example, a carbon material in powder form is mixed with a first binder and a suitable amount of a first dispersion medium, to form a first paste. The first dispersion medium can be water, N-methyl-2-pyrrolidone, or the like.

The first paste is applied onto each face of a current collector to form a first coating.

To make it difficult for the first coating to be embedded into the through-holes, the ratio of the dispersion medium in the first paste is preferably 800 parts by weight or less per 100 parts by weight of the carbon material.

To ensure stable application to each face of the current collector, the ratio of the dispersion medium in the first paste is more preferably 300 parts by weight or more per 100 parts by weight of the carbon material.

The method for applying the first paste can be a conventional method. Exemplary methods include reverse roll coating, direct roll coating, blade coating, knife coating, extrusion coating, curtain coating, gravure coating, bar coating, casting coating, dip coating, and squeeze coating. Among them, blade coating, knife coating, and extrusion coating are preferable. Also, the application method can be a continuous, intermittent, or strip method.

To make it difficult for the first coating to be embedded into the through-holes, blade coating is particularly preferable as the application method.

In order to prevent the first paste from being excessively embedded into the through-holes and form a good coating, it is preferable to apply the first paste at a speed of 0.5 to 12 m/min. The application method can be selected from the above-listed ones according to the drying properties of the first coating. This can provide a carbon layer in a good surface state.

Next, the first coating is dried to form a carbon layer.

To form a carbon layer stably without filling the first coating excessively into the through-holes, it is preferable to dry the first coating with a blower. Preferable drying conditions are a drying temperature of 80 to 120° C. and a drying time of 10 to 30 minutes. By employing such conditions, in the step (a), most of the first paste applied over the openings of the through-holes is applied so as to cover the openings of the through-holes around the openings, so that the first coating is not densely embedded into the through-holes. Therefore, the carbon material is not densely filled into the through-holes and the regions extending from the through-holes in the thickness direction of the current collector (the hole-filling parts and the extended parts), so that a less-dense carbon layer is formed therein.

### Step (b): Step for Forming Mixture Layer

A second paste can be prepared, for example, by mixing an active material with a conductive agent, a second binder, and a suitable amount of a second dispersion medium. The second dispersion medium can be water, N-methyl-2-pyrrolidone, or the like. The second dispersion medium may be the same as or different from the first dispersion medium. The second binder may be the same as or different from the first binder.

In order to form a coating stably on the surface of the carbon layer, the ratio of the dispersion medium in the second paste is preferably 80 to 150 parts by weight per 100 parts by weight of the active material.

The second paste is applied onto the carbon layer to form a second coating. The application method of the second paste can be the same as that of the first paste. To form a good coating, it is preferable to apply the second paste at a speed of 0.5 to 5 m/min.

The second coating is dried with a blower to form a mixture layer. Preferable drying conditions are a drying temperature of 80 to 120° C. and a drying time of 10 to 30 minutes.

### Step (c): Step for Increasing Adhesion Between Current Collector, Carbon Layer, and Mixture Layer

After the step (b), a negative electrode precursor, in which the carbon layer and the mixture layer are formed on each face of the current collector, is compressed with a pair of rollers at a predetermined linear pressure to produce a negative electrode.

The linear pressure applied to the negative electrode precursor by the pair of rollers is preferably 1000 to 3000 kgf/cm, and more preferably 1500 to 2500 kgf/cm. By setting the linear pressure to 3000 kgf/cm or less, it is possible to suppress the carbon layer from being densely embedded into the through-holes in a reliable manner. By setting the linear pressure to 1000 kgf/cm or more, the active material density of the mixture layer can be made high and the energy density of the battery can be heightened. Also, the strength of the negative electrode (the adhesion between the mixture layer and the carbon layer) becomes sufficient.

The carbon layer formed in the through-holes and the regions extending from the through-holes in the thickness direction of the current collector in the step (a) is not sufficiently compressed by the step (c) due to the presence of the through-holes. Therefore, even after the step (c), the carbon material is not densely filled into the through-holes and the regions extending from the through-holes in the thickness direction of the current collector, and a less-dense carbon layer is formed therein. The density of the less-dense carbon layer is particularly low inside the through-holes.

On the other hand, the carbon layer on the surface of the current collector is sufficiently pressed and compressed against the current collector in the step (c). As a result, the layer becomes dense, thereby providing good adhesion between the current collector, the mixture layer, and the current collector.

### EXAMPLES

Examples of the invention are hereinafter described in detail, but the invention is not to be construed as being limited to these Examples.

### Examples 1 to 4 and Comparative Examples 1 and 2

### (1) Preparation of Negative Electrode

A negative electrode with a structure as illustrated in FIG. 1 was prepared in the following manner.

### a) Formation of Carbon Layer

A first paste was prepared by adding 700 parts by weight of N-methyl-2-pyrrolidone serving as a dispersion medium to a mixture of 100 parts by weight of an acetylene black powder (available from Denki Kagaku Kogyo K.K., mean particle size 35 nm) as a carbon material and 230 parts by weight of polyvinylidene fluoride resin (available from Kureha Corporation) as a binder. The first paste was applied onto each face of a negative electrode current collector with a comma coater at a speed of 1 m/min, to form a first coating. The negative electrode current collector used was a perforated aluminum metal sheet (void ratio 40%, thickness T 20 μm, average opening diameter 500 μm, interval L 500 μm) prepared by punching. The first coating covered each face of the negative electrode current collector so as to form a continuous flat layer without being excessively embedded into the through-holes. The first coating was dried with a blower to form a carbon layer (first layer). The drying temperature was set to 80° C., and the drying time was set to 20 minutes.

### b) Formation of Mixture Layer

A second paste was prepared by adding 100 parts by weight of N-methyl-2-pyrrolidone serving as a dispersion medium to a mixture of 85 parts by weight of a Li₄Ti₅O₁₂(Li_{1/3}[Li_{1/3}Ti_{5/3}]O₄) powder (mean particle size 1 μm) as an active material, 10 parts by weight of an acetylene black powder (available from Denki Kagaku Kogyo K.K., mean particle size 35 nm) as a conductive agent, and 5 parts by weight of polyvinylidene fluoride resin (available from Kureha Corporation) as a binder. The second paste was applied onto the surface of the carbon layer with a comma coater at a speed of 1 m/min, to form a second coating. The amount of the second coating applied was set to 7.5 mg/cm². The second coating was dried with a blower, to form a mixture layer (second layer). The drying temperature was set to 80° C., and the drying time was set to 20 minutes. In this manner, a negative electrode precursor was prepared.

The negative electrode precursor was compressed with a pair of rollers, and cut to a rectangular shape with a predetermined size (240 mm in length, 55 mm in width), to obtain a negative electrode. One end of the negative electrode was provided with an exposed part of the current collector to which a negative electrode lead was to be welded as described below.

In forming the negative electrode, the average density of the carbon layer was changed to values shown in Table 1 to produce negative electrodes A1 to A4 of Examples 1 to 4 and negative electrodes B1 and B2 of Comparative Examples 1 and 2. Specifically, the linear pressure applied to compress the negative electrode precursor by the pair of rollers was changed in the range of 500 to 3500 kgf/cm. The amount of the first paste applied was changed in the range of 0.05 to 0.8 mg/cm² so that the thickness T_{c} of the surface-covering parts after the compression was approximately 15 μm. After the compression, the thickness Tₘ of the negative electrode mixture layer was 37 to 44 μm, the thickness T_{c} of the surface-covering parts of the carbon layer was 14 to 17 μm, and the amount of active material per 1 cm³ of the negative electrode mixture layer was 2.0 to 2.5 g.

The average density of the carbon layer of each negative electrode was determined by the following formula:

average density of carbon layer=(amount of carbon material filled)/(volume of surface-covering parts+total volume of through-holes)

The volume of the surface-covering parts was obtained by multiplying the area of the surface-covering parts facing the current collector (including the through-holes) and the thickness of the surface-covering parts together. The total volume of the through-holes was obtained by multiplying the volume of one through-hole, determined from the average diameter of the through-holes and the thickness of the current collector, and the number of the through-holes together.

The ratio P (% by volume) of the non-aqueous electrolyte in the through-holes of the current collector of each negative electrode was determined by the following method.

A cross-section of the negative electrode in the thickness direction (a cross-section including the axes of the cylindrical through-holes) was observed with a scanning electron microscope (SEM). As a result, it was found that the carbon material was not densely filled into the through-holes, in particular, the hole-filling parts, so that spaces for retaining the electrolyte were formed therein.

The SEM image was processed to determine the ratio of the volume Rᵥ of the spaces inside the through-holes in which the electrolyte was retained to the volume Qᵥ of the through-holes, i.e., the ratio Rᵥ/Qᵥ. The value P was given as Rᵥ/Qᵥ×100.

The volume Rᵥ of the spaces inside the through-holes in which the electrolyte was retained was determined by binarizing the SEM image so that the spaces inside the through-holes could be clearly identified. The magnification of the image (projected image) was 600. The area of the image (projected image) was 100 μm×100 μm. The number of pixels dividing the image (projected image) was 1024×1024. Each pixel was binarized. This process was applied to a cross-section of one through-hole in the thickness direction of the negative electrode.

This operation was applied to five through-holes of the current collector. The average value was obtained.

### (2) Preparation of Positive Electrode

A positive electrode paste was prepared by adding 50 parts by weight of N-methyl-2-pyrrolidone serving as a dispersion medium to a mixture of 85 parts by weight of a lithium cobaltate (LiCoO₂) powder as an active material, 10 parts by weight of an acetylene black powder as a conductive agent, and 5 parts by weight of polyvinylidene fluoride resin as a binder. The positive electrode paste was applied onto each face of a positive electrode current collector comprising aluminum foil (thickness 15 μm) at a speed of 1 m/min with a comma coater, to form a coating. This coating was dried with a blower to form a mixture layer, thereby producing a positive electrode precursor. The drying temperature was set to 80° C., and the drying time was set to 20 minutes.

The positive electrode precursor was compressed at a linear pressure of 2000 kgf/cm and cut to a rectangular shape with a predetermined size (200 mm in length and 50 mm in width), to produce a positive electrode. The thickness of the mixture layer was 30 μm. One end of the positive electrode was provided with an exposed part of the current collector to which a positive electrode lead was to be welded as described below.

### (3) Assembly of Battery

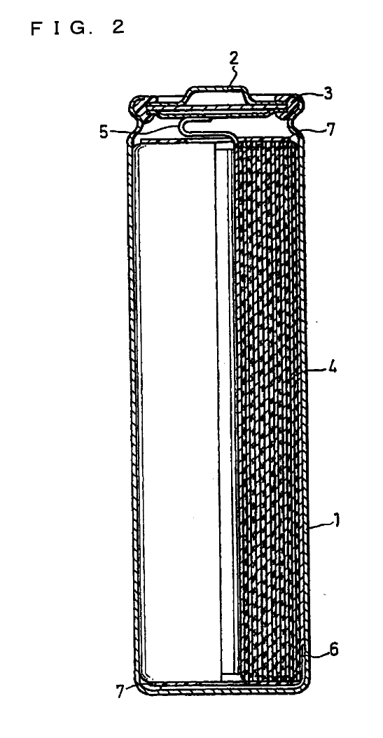

The positive electrode and the negative electrode were spirally wound with a separator interposed between the positive electrode and the negative electrode, to form an electrode assembly 4. The separator used was a microporous film (thickness 20 μm) made of polyethylene. The electrode assembly 4 was placed inside a stainless steel battery case 1. One end of an aluminum positive electrode lead 5 was connected to the positive electrode. The other end of the positive electrode lead 5 was connected to a seal plate 2. One end of an aluminum negative electrode lead 6 was connected to the negative electrode. The other end of the negative electrode lead 6 was connected to the bottom of the battery case 1. The upper and lower portions of the electrode assembly 4 were fitted with resin insulating rings 7. A non-aqueous electrolyte was injected into the battery case 1. The non-aqueous electrolyte used was composed of a non-aqueous solvent and LiPF₆ dissolved therein. The non-aqueous solvent was a solvent mixture (volume ratio 3:7) of ethylene carbonate (EC) and diethyl carbonate (DEC). The concentration of LiPF₆ in the non-aqueous electrolyte was 1.0 mol/L. The open edge of the battery case 1 was crimped onto the periphery of the seal plate 2 with a resin seal member 3 interposed therebetween, to seal the battery case 1. In this manner, a cylindrical battery (diameter 18 mm, height 65 mm) of FIG. 2 was produced. Specifically, using the negative electrodes A1 to A4 of Examples 1 to 4, batteries A1 to A4 were produced. Also, using the negative electrodes B1 and B2 of Comparative Examples 1 and 2, batteries B1 and B2 were produced.

### Comparative Example 3

Without forming a carbon layer, a negative electrode paste was applied directly onto each surface of a negative electrode current collector at a speed of 1 m/min by blade coating to form a coating. The negative electrode paste used was the second paste of Example 1. The negative electrode current collector used was the negative electrode current collector of Example 1. Upon the application, part of the coating was embedded into the through-holes. The coating was dried with a blower to form a mixture layer. The drying temperature was set to 80° C., and the drying time was set to 20 minutes. Part of the mixture layer was formed in the through-holes. In this manner, a negative electrode precursor was prepared.

Using the negative electrode precursor, a negative electrode C was produced in the same manner as in Example 1. The thickness of the mixture layer was 41 μm. A cylindrical battery C was produced in the same manner as in Example 1 except for the use of the negative electrode C instead of the negative electrode A1.

### Comparative Example 4

A negative electrode D was produced in the same manner as in Example 1 except for the use of an aluminum foil (thickness 15 μm) having no through-holes as the negative electrode current collector instead of the perforated metal sheet. A cylindrical battery D was produced in the same manner as in Example 1 except for the use of the negative electrode D instead of the negative electrode A1.

### Comparative Example 5

Without forming a carbon layer, a negative electrode paste was applied directly onto each surface of a negative electrode current collector at a speed of 1 m/min with a comma coater to form a coating. The negative electrode paste used was the second paste of Example 1. The negative electrode current collector used was the aluminum foil (thickness 15 μm) of Comparative Example 4. The coating was dried to form a mixture layer. The drying temperature was set to 80° C., and the drying time was set to 20 minutes. In this manner, a negative electrode precursor was prepared.

Using the negative electrode precursor, a negative electrode E was produced in the same manner as in Example 1. The thickness of the mixture layer was 39 μm. A cylindrical battery E was produced in the same manner as in Example 1 except for the use of the negative electrode E instead of the negative electrode A1.

The production conditions of the above negative electrodes are summarized in Table 1.

TABLE 1

| | | Production condition of | | | | Carbon layer | | Mixture layer | |
|---|---|---|---|---|---|---|---|---|---|
| | | negative electrode | | | | | Thickness | Amount of active | |
| | Negative | Form of | | | Linear | Average | T_{c} of surface | material per 1 | Thickness |
| | electrode | current | Through- | Carbon | pressure | density | covering | cm³ of mixture | Tₘ |
| | No. | collector | hole | layer | (kgf/cm) | (g/cm³) | portion (μm) | layer (g) | (μm) |
| Comp | B1 | Perforated | Present | Present | 500 | 0.03 | 17 | 2.5 | 44 |
| Ex 1 | | metal | | | | | | | |
| Ex 1 | A1 | Perforated | Present | Present | 1000 | 0.05 | 16 | 2.3 | 42 |
| | | metal | | | | | | | |
| Ex 2 | A2 | Perforated | Present | Present | 1500 | 0.1 | 16 | 2.2 | 41 |
| | | metal | | | | | | | |
| Ex 3 | A3 | Perforated | Present | Present | 2000 | 0.3 | 15 | 2.2 | 41 |
| | | metal | | | | | | | |
| Ex 4 | A4 | Perforated | Present | Present | 3000 | 0.4 | 15 | 2.1 | 39 |
| | | metal | | | | | | | |
| Comp | B2 | Perforated | Present | Present | 3500 | 0.5 | 14 | 2.0 | 37 |
| Ex 2 | | metal | | | | | | | |
| Comp | C | Perforated | Present | Absent | 2000 | — | — | 2.2 | 41 |
| Ex 3 | | metal | | | | | | | |
| Comp | D | Foil | Absent | Present | 3000 | 0.5 | 14 | 2.3 | 42 |
| Ex 4 | | | | | | | | | |
| Comp | E | Foil | Absent | Absent | 2000 | — | — | 2.1 | 39 |
| Ex 5 | | | | | | | | | |

### [Evaluation]

### (1) Measurement of Direct Current Internal Resistance

To evaluate the rate characteristics, the following measurements were made.

In an environment of 25° C., the batteries were charged at a constant current of 1 A until the charge capacity reached 60% of the full charge. Under the conditions shown in Table 2 below, the batteries with an SOC of 60% were intermittently charged and discharged by changing the current value within the range of 100 to 2000 mA.

TABLE 2

| Step | Mode | Current (mA) | Time (sec) | Rest time (sec) |
|---|---|---|---|---|
| 1 | Discharge | 100 | 10 | 300 |
| 2 | Charge | 100 | 10 | 300 |
| 3 | Discharge | 200 | 10 | 300 |
| 4 | Charge | 200 | 10 | 300 |
| 5 | Discharge | 500 | 10 | 300 |
| 6 | Charge | 500 | 10 | 300 |
| 7 | Discharge | 1000 | 10 | 300 |
| 8 | Charge | 1000 | 10 | 300 |
| 9 | Discharge | 2000 | 10 | 300 |
| 10 | Charge | 2000 | 10 | 300 |

The discharge voltages after 10 seconds from the start of the discharge in steps 1, 3, 5, 7, and 9 were measured, and plotted against the current values. This plot was linearly approximated by the least squares method, and the values of the inclination of the straight line were defined as direct current internal resistance (DCIR). A smaller DCIR value represents a higher output characteristic and a better rate characteristic.

### (2) Charge/Discharge Cycle Test

In an environment of 25° C., a charge/discharge cycle test was performed under the following conditions.

Charge condition: charge the batteries at a constant current of 1 A until the battery voltage reaches 4.2 V, and then charge them at a constant voltage of 4.2 V until the current value decreases to 0.1 A.

Discharge condition: discharge the batteries at a constant current of 1 A until the battery voltage reaches 1.5 V.

The number of charge/discharge cycles was 500 cycles, and the capacity retention rate was determined from the discharge capacities at the 1^{st} cycle and 500^{th} cycle by the following formula.

Capacity retention rate (%)=discharge capacity at 500^{th} cycle/discharge capacity at 1^{st} cycle×100

The test results are shown in Table 3.

TABLE 3

| | | | | | | | Rate | Cycle |
|---|---|---|---|---|---|---|---|---|
| | | Negative electrode | | | | | characteristic | characteristic |
| | | | | | Average | Ratio P of | evaluation | evaluation |
| | Battery No. | Form of | | | density | electrolyte | Discharge time | Capacity |
| | (negative | current | Through- | Carbon | of carbon | in through- | at large current | retention |
| | electrode) | collector | hole | layer | layer (g/cm³) | hole (%) | (indices) | rate (%) |
| Comp | B1 | Perforated | Present | Present | 0.03 | 95 | 133 | 70 |
| Ex 1 | | metal | | | | | | |
| Ex 1 | A1 | Perforated | Present | Present | 0.05 | 90 | 235 | 88 |
| | | metal | | | | | | |
| Ex 2 | A2 | Perforated | Present | Present | 0.1 | 85 | 225 | 92 |
| | | metal | | | | | | |
| Ex 3 | A3 | Perforated | Present | Present | 0.3 | 55 | 215 | 95 |
| | | metal | | | | | | |
| Ex 4 | A4 | Perforated | Present | Present | 0.4 | 30 | 200 | 89 |
| | | metal | | | | | | |
| Comp | B2 | Perforated | Present | Present | 0.5 | 25 | 130 | 72 |
| Ex 2 | | metal | | | | | | |
| Comp | C | Perforated | Present | Absent | — | — | 110 | 65 |
| Ex 3 | | metal | | | | | | |
| Comp | D | Foil | Absent | Present | 0.5 | — | 125 | 66 |
| Ex 4 | | | | | | | | |
| Comp | E | Foil | Absent | Absent | — | — | 100 | 63 |
| Ex 5 | | | | | | | | |

The batteries A1 to A4 of Examples 1 to 4 of the invention used negative electrodes with good electrolyte retention and electronic conductivity. Thus, they exhibited significant improvements in rate characteristic and cycle characteristic, compared with the batteries B1, B2 and C to E of Comparative Examples 1 to 5.

The battery C of Comparative Example 3 used the same current collector as that of the battery A1 of Example 1. However, when the battery C was disassembled and a cross-section of its negative electrode was observed, it was confirmed that the mixture layer was densely filled into the through-holes, and that there were no spaces for retaining the electrolyte.

In the foregoing Examples, current collectors with a void ratio of 40% were used, but even when the void ratio of a current collector is not 40%, if the void ratio of the current collector is 20 to 60%, the same effects as those of the foregoing Examples of the invention can be obtained.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

The non-aqueous electrolyte secondary batteries of the invention, which have good output characteristics, can be advantageously used as the batteries for automobiles.

1. A negative electrode for a non-aqueous electrolyte secondary battery, comprising:
a sheet-like current collector with a plurality of through-holes;
a carbon layer formed on a surface of and in the through holes of the current collector; and
a mixture layer formed on a surface of the carbon layer,
wherein the mixture layer includes an active material and a conductive agent, the active material comprises a lithium-titanium containing composite oxide with a spinel crystal structure,
the current collector has a void ratio of 20 to 60%, and
the carbon layer has an average density of 0.05 to 0.4 g/cm³.

2. The negative electrode for a non-aqueous electrolyte secondary battery in accordance with claim 1, wherein the through-holes have an average diameter of 100 to 700 μm.

3. The negative electrode for a non-aqueous electrolyte secondary battery in accordance with claim 1, wherein the content of the active material in the mixture layer is 1.5 to 2.3 g per 1 cm³ of the mixture layer.

4. The negative electrode for a non-aqueous electrolyte secondary battery in accordance with claim 1, wherein the lithium-titanium containing composite oxide is represented by the general formula:
Li₄₊ₓTi_{5-y}M_{y}O_{12+z}
where M is at least one selected from the group consisting of Mg, Al, Ca, Ba, Bi, Ga, V, Nb, W, Mo, Ta, Cr, Fe, Ni, Co, and Mn, −1≦x≦1, 0≦y≦1, and −1≦z≦1.

5. A non-aqueous electrolyte secondary battery comprising a positive electrode, a negative electrode, a separator disposed between the positive electrode and the negative electrode, and a non-aqueous electrolyte,
wherein the negative electrode is the negative electrode of claim 1.

6. The non-aqueous electrolyte secondary battery in accordance with claim 5, wherein 30 to 90% by volume of the spaces inside the through-holes of the current collector are filled with the non-aqueous electrolyte.

7. A method for producing a negative electrode for a non-aqueous electrolyte secondary battery, comprising the steps of:
(a) applying a first paste including a carbon material onto a surface of a sheet-like current collector having a plurality of through-holes and a void ratio of 20 to 60% and drying it to form a carbon layer on a surface of and in the through-holes of the current collector;
(b) applying a second paste including a lithium-titanium containing composite oxide with a spinel crystal structure as an active material and a conductive agent onto a surface of the carbon layer and drying it to form a mixture layer, thereby producing a negative electrode precursor; and
(c) compressing the negative electrode precursor such that the carbon layer has an average density of 0.05 to 0.4 g/cm³, to produce a negative electrode.

8. The method for producing a negative electrode for a non-aqueous electrolyte secondary battery in accordance with claim 7, wherein the lithium-titanium containing composite oxide is represented by the general formula:
Li₄₊ₓTi_{5-y}M_{y}O_{12+z}
where M is at least one selected from the group consisting of Mg, Al, Ca, Ba, Bi, Ga, V, Nb, W, Mo, Ta, Cr, Fe, Ni, Co, and Mn, −1≦x≦1, 0≦y≦1, and −1≦z≦1.
